(19) United States
(12) Patent Application Publication
(10) Pub. No.: US 2026/0326394 A1
(43) Pub. Date: Oct. 22, 2026

(54) HOT MOLDING METHOD

(71) Applicant: ALIA MENTIS S.R.L., Vedelago (IT)

(72) Inventors: Giuseppe PARONETTO, Vedelago (IT); Luca TESSARO, Vedelago (IT); Giampietro PARONETTO, Vedelago (IT); Giorgia DANIEL, Vedelago (IT)

(21) Appl. No.: 19/107,574

(22) PCT Filed: Aug. 19, 2023
(86) PCT No.: PCT/IB2023/058303

§ 371 Date: Feb. 28, 2025

(30) Foreign Application Priority Data
Aug. 29, 2022 (IT) 102022000017691

(51) Int. Cl. B29C 67/20; B29C 44/44; B29C 70/02; B29K 63/00; B29K 105/00; B29K 105/04

(52) U.S. Cl. CPC B29C 67/207; B29C 44/445; B29C 70/025; B29K 2063/00; B29K 2105/0076; B29K 2105/048

(57) ABSTRACT

A hot-molding method is described for a powder material comprising expanded particles and unexpanded particles,
wherein said powder material is coated with epoxy while it is kept stirring to thicken the material.

The invention relates to a method for hot molding. In particular, the method is convenient for molding solid composite objects with an inner core and an outer shell made of carbon.

It is known from EP 3 372 366 that the material in EP 2 697 028 is not without drawbacks and has the problem of being highly volatile. EP 3 372 366 solves the problem by spraying the material with water, oil, a phthalate, a glycol, or a high-boiling hydrocarbon. However, experience has proven that an object produced by molding the material treated in this way tends to fracture or crack, which is undesirable especially when the molded part is an inner core of a valuable carbon-coated object.

The main object of the invention is to propose a different method of molding with the above-mentioned material.

Another object of the invention is to propose a molding method with the above material that cancels or at least mitigates the problems encountered with the method of EP 3 15 372 366.

A method is then proposed for hot molding a powder material comprising—or consisting of—expanded particles and non-expanded particles, the particles being made of plastic material, closed in shape, hollow and filled with gas, and comprises the step of coating the particles with epoxy resin by depositing on the particles a micrometrical layer of resin before molding.

The coating step has various embodiments, e.g. it takes place by
spraying epoxy resin on the material, and/or
atomizing epoxy resin on the material (e.g. well-known foggers or atomizers may be used as sprayers), and/or
kneading, through mechanical action, the material with epoxy resin, more preferably by placing the powder material and epoxy resin inside a container and deforming the container so as to mix and knead the content thereof until a homogeneously wet paste is obtained. Preferably the container is a deformable container, such as a silicone bag, and the kneading is done by pressing the container.

The step of coating preferably occurs before and/or during the transport of the material inside the mold, more preferably while the material is kept stirring; or it may also occur during the application or sitting of the material inside the mold.

The spraying of the epoxy resin has the effect of aggregating the particles of the powder material, thereby preventing them from floating in the environment. The wet material forms a wet, sticky mush that is easily spreadable inside a mold, particularly on top of a fiber-reinforced layer to which the shape of the mold cavity is desired to be transferred.

Preferably, in the step of depositing, an amount of epoxy resin ranging from 1 to 300 wt. % of the powder material is added overall to the powder material, particularly 3 to 250%, more preferably 5 to 200%. These values experimentally gave the best results.

Plastic, gas-filled microspheres may be used as particles.

Specifically, the powder material to be molded is preferably composed by weight of 10-70% of expanded microspheres and 90-30% of non-expanded microspheres, the microspheres being made of plastic material, closed in shape, hollow and filled with (flammable) gas. These values ensure advantageous performance and weight suitable for the applications, particularly excellent results of impact absorption and lightness. The expanded microspheres are essential to the invention, and act as the binder or filler for the other non-expandable particles. In fact, the expanded microspheres are the filling element (filler) and act as a binder by preventing the other expandable (not yet expanded) microspheres, which are heavier, from precipitating by gravity to the bottom of the mold and thickening. Instead, this way the expanded microspheres keep the expanding microspheres suspended and uniformly throughout the material. This is why the presence of expanded and unexpanded microspheres ensures the homogeneity of the density of the entire piece, guaranteeing the uniformity of mechanical performance.

The microspheres are generally spherical in shape and are very small (10-40 μm diameter). Note, however, that the size is not essential.

We define here by the term core an object obtained by molding only the powder material.

An advantage of said material is that it gives the core shape memory. When the core undergoes a deformation, the expanded and unexpanded microspheres will compress or expand inside its mass. Due to the elasticity of the microspheres, when the stress ceases each microsphere returns to its original state, and consequently the material regains its original shape.

Note also that the core can react to a second deformation in the same way as to the first, with obvious advantages of safety and repeatability of the response to a bump.

The core is preferably used as an expanding core or nucleus in the molding of a fiber-reinforced material. The core expands inside the mold and pushes the fiber-reinforced material toward the mold walls, actually filling all the cavities thanks to the particle expansion, compacting the layers of material and enabling excellent mold copying for the fiber-reinforced material.

E.g. in the method
the powder material coated with epoxy resin is baked in a mold to form a solid core,
the solid core is put into a cavity of a mold, and a layer of fiber-reinforced material is applied between a surface of the mold cavity and the core,
the assembly of core and fiber-reinforced material is baked in the mold until the fiber-reinforced material solidifies forming a composite object that has a rigid outer shell made of the solidified reinforced material and as an inner core said solid core.

E.g. in the method
a layer of fiber-reinforced material is applied to a mold cavity,
the thickened material is put on the fiber-reinforced material,
the mold cavity is closed and the two materials are heated inside the cavity,
   in a variation, the layer of fiber-reinforced material is applied directly to the core, or also to the mold and core together.

Or in the method
a cavity of a mold is filled with said powder material added with epoxy resin,
the mold cavity is closed and the material is heated inside the cavity to bring the material to baking and to solidify the material in order to form a solid piece,
a layer of fiber-reinforced material is applied to the surface of a cavity of a mold,
the solid piece is put into the mold cavity,
the mold cavity is closed,
the solid piece and the layer inside the cavity are heated to solidify the layer and obtain a composite piece.

An advantage of spraying the powder material with epoxy resin is that it gives the core more rigidity without infusing it with fracture criticality. This is true not only during molding the core alone or during molding the core together with the fiber-reinforced material, but also during the life of the final composite piece. In fact, although the epoxy resin is inherently a glassy material that tends to break, in small amounts, when it forms a thin film on the microspheres, surprisingly it can flex without fracturing. Spraying epoxy on the microspheres exploits the behavior of the solid resin at the micrometrical level, which is no longer that of an ordinary lamina which shatters but of a skin able to flex elastically. Therefore, said film gives the core flexibility and resistance.

The layer of resin deposited on each microsphere has (average) thickness ranging from a few microns (=one millionth of a meter) to a few hundredths of mm, e.g. from 1 μm to 300 hundredths of mm. Statistically, the thickness can also vary from particle to particle given the stochastic nature of the deposition technique.

The spraying of the epoxy resin on the powder material activates and amplifies the change in under-stress behavior of the hardened resin (from brittle to elastic), because the resin finds surface area on which to spread with micrometrical thickness. As a result, the molded core becomes elastic and has shape memory.

Another surprising effect is that the aforementioned film of epoxy resin when stressed also has the ability to return to the original shape after the stress has disappeared.

The epoxy resin also solves the problem of gas released from the core into the composite object when subjected to high temperature after molding (think of an object operating in the Sahara), which causes deformation and structural stress. The epoxy resin manages to keep the gas which escapes locally from the material encapsulated where it is, without the gas being able to aggregate with other nearby gas dispersions to form a bubble. The epoxy is not gas-permeable, and it forms a crystalline skin, on the microsphere on which it is deposited, that traps the gas.

The epoxy resin also solves the problem of unwanted re-expansion of the core when returned to high temperature, e.g. 90-100 °C (think of an object operating in the Sahara). The core tends to change shape by as much as 0.5-5% in linear dimension because the unexpanded microspheres are always prone to expansion. The epoxy resin is, as mentioned, elastic, but it has limited elasticity and actually forms an internal constraint for an uncontrolled or excessive expansion, thereby ensuring the dimensional quality of the object.

Theory says that the epoxy resin is a thermoset: after it has reacted, it no longer changes shape. It would seem a nonsense then to use epoxy resin for the inner core when molding the core or a carbon object, where it is desired that the core during molding still expands to copy the mold cavity itself or presses (i.e. expands) against the carbon to make it copy the mold cavity. Surprisingly, however, during molding under the pressure of the expanding microspheres the epoxy resin yields (also helped by its own softening due to heat inside the mold), deforms, allows the expansion of the core and then retains the acquired shape when the core cools down.

Finally, another advantage of epoxy resin is that when the microspheres are wetted by it, a lower quantity of microspheres can be used. A lower density of material for the same volume in the finished core is enough (up to ⅓ of the weight of material for the same volume). The particles wetted by resin arrange relatively quite randomly at first contact, even disjointed and not perfect, instead of flowing and fitting perfectly together as is the case with sand. The greater space between them entails that the wet powder material has lower density.

Another aspect of the invention relates to said powder material with particles coated with epoxy resin, considered as a precursor and intermediate, self-contained product for hot molding.

Another aspect of the invention relates to a solid expandable core insertable into a mold to mold a composite-material object, e.g. comprising carbon, comprising the, or consisting solely of, powder material with epoxy resin-coated particles according to any of the variations defined above, wherein the powder material has been hot molded inside a mold to produce the core.

Another aspect of the invention concerns a composite object produced through hot molding in a mold, formed of
an aforementioned internal expanding core and
an outer shell that covers the abovementioned core and is made of a fiber-reinforced layer solidified after baking in a mold.

Advantageous examples of a fiber-reinforced layer exploited in the method and composite object are layers of carbon or glass or aramid fibers.

1. Method for hot molding a powder material comprising—or consisting of—expanded particles and unexpanded particles, the particles being made of plastic material, of closed shape, hollow and filled with gas,
wherein a micrometrical layer of epoxy resin is deposited on the particles before molding.

2. Method according to claim 1, wherein the epoxy resin is sprayed onto the powder material.

3. Method according to claim 1, wherein the powder material is kneaded with epoxy resin inside a container.

4. Method according to claim 1, wherein an amount of epoxy resin ranging from 1-% to 300% by weight of the powder material is added to the powder material.

5. Method according to claim 1, wherein
said epoxy coated powder material is baked in a mold to form a solid core,
the solid core is placed in a cavity of a mold and a layer of fiber-reinforced material is applied between a surface of the mold cavity and the core,
the assembly of core and fiber-reinforced material is baked in the mold until solidification of the fiber-reinforced material thereby forming a composite object which has an external rigid shell made of the solidified reinforced material and said solid core as an internal core.

6. (canceled)

7. (canceled)

8. Material according to claim 14, wherein the layer has a thickness ranging from 1 μm to 300 hundredths of a mm.

9. Expanding core insertable into a mold to mold a composite material object comprising, or consisting solely of, the material according to claim 14.

10. Composite object produced by hot molding in a mold, formed of
an internal expanding core according to claim 9, and
an external shell which covers said core and is made of a layer of carbon fibers solidified after baking in a mold.

11. Method according to claim 2, wherein the powder material is kneaded with epoxy resin inside a container.

12. Method according to claim 1, wherein the powder material is composed by weight of 10-70% of expanded particles and 90-30% of unexpanded particles.

13. Method according to claim 1, wherein the layer has a thickness ranging from 1 μm to 300 hundredths of a mm.

14. Powder material for hot molding, comprising—or consisting of—expanded particles and unexpanded particles, the particles being made of plastic material, of closed shape, hollow and filled with gas,
comprising a micrometrical layer of epoxy resin deposited on the particles.

15. Material according to claim 14, wherein the powder material is composed by weight of 10-70% of expanded particles and 90-30% of unexpanded particles.

16. Material according to claim 15, wherein the layer has a thickness ranging from 1 μm to 300 hundredths of a mm.

17. Expanding core according to claim 9, wherein the object comprises carbon.
